(19) United States
(12) Patent Application Publication
(10) Pub. No.: US 2008/0012676 A1
(43) Pub. Date: Jan. 17, 2008

(54) Inverter Transformer

(75) Inventor: Shinichi Suzuki, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., Kitasaku-gun (JP)

(21) Appl. No.: 11/664,519

(22) PCT Filed: Nov. 1, 2005
(86) PCT No.: PCT/JP05/20110

§ 371 Date: May 11, 2007

(30) Foreign Application Priority Data
Nov. 2, 2004 (JP) 2004-319384
Mar. 1, 2005 (JP) 2005-055951

(51) Int. Cl. H01F 17/06

(52) U.S. Cl. 336/178

(57) ABSTRACT

An inverter transformer includes: a one end open core which is integrally composed of two side legs, one or more inner legs, and a connection bar to connect respective one ends of the side and inner legs while the other ends of the side and inner legs are separated from each other; and at least one bobbin which is provided in a number corresponding to the number of the inner legs and which each have primary and secondary windings wound therearound. The bobbin is restricted from tilting such that the bobbin has projections formed at the both lateral sides of its distal end portion and supported by the reverse faces of the side legs of the magnetic core, and such that the bobbin has its proximal end portion supported by the connection bar of the magnetic core.

### BACKGROUND OF THE INVENTION

1. Field of the Invention

The present invention relates to an inverter transformer disposed at an output stage of an inverter circuit to drive a light source of a backlight device for a liquid crystal display.

2. Description of the Related Art

Recently, a liquid crystal display (hereinafter referred to as LCD) is extensively used as a display device for a personal computer, and the like. The LCD requires a lighting system such as a backlight for illuminating its screen. In order to illuminate such a LCD screen brightly, a plurality of cold cathode fluorescent lamps (hereinafter referred to as CCFL) are used as the light source and are discharged and lit simultaneously.

Generally, at the time of starting discharging a CCFL, a high frequency voltage of about 60 kHz and 1600 V is to be generated out of a DC input voltage of about 12 V at the secondary side of an inverter transformer, and therefore an inverter circuit is employed which includes an inverter unit incorporating a full bridge circuit or a Royer circuit and adapted to drive a backlight. Once the CCFL discharge starts, such an inverter circuit operates to step the voltage at the secondary side of the inverter transformer down to about 600 V which is required for keeping the CCFL discharging. Usually, this voltage control operation is performed by pulse width modulation (PWM).

In such an inverter unit, a leakage transformer is used, which includes a magnetic core (hereinafter referred to simply as “core” as appropriate) such as an EE-core, a UI-core, a CI-core, or I-core. The leakage transformer has its primary-to-secondary coupling efficient set at 0.95 or smaller thereby increasing the leakage inductance, and the length of a magnetic path is increased or the turn number of a secondary winding is increased. In a backlight inverter, a resonance circuit is composed of a leakage inductance of a leakage transformer, a parasitic capacitance formed at an LCD, and an additional capacitance, and a CCFL is driven at a frequency found about halfway between the series resonance frequency and the parallel resonance frequency of the resonance circuit.

An inverter transformer may use an I-core for an open magnetic path structure (refer to Patent Document 1) or use an EE-core, a UI-core, or a CI-core for a closed magnetic circuit structure (refer to Patent Documents 2, 3 and 4).

In an inverter transformer with a closed magnetic path structure using an EE-core, UI-core, or a CI-core as described above, since the frame core has a small gap, and since the bar core (I-core) is separate from the frame core, such problems are caused as an irregular gap, and a poor attachment of a bobbin when coupling the separate cores and putting them together with a bobbin. As a result, variation in leakage inductance is increased, and variance in resonance frequency is given at the secondary side of the transformer, thus causing a fluctuation in current flowing in a CCFL.

Also, the closed magnetic path is structured such that two E-cores are put together, or a quadrangular frame core is coupled to a bar core to be inserted in a bobbin, thus requiring two or more cores, which pushes up the component cost. And, additional processes of providing a uniform inductance are required when coupling the cores, thus inviting an increase in the production cost.

On the other hand, in an inverter transformer with an open magnetic path structure, primary and secondary windings are disposed around a bar core thus easily achieving leakage inductance, but since magnetic flux goes through the space near the transformer, eddy current loss occurs at a copper pattern and a metal positioned closed to the transformer, thus significantly deteriorating efficiency.

Patent Document Japanese Patent Application Laid-Open No. 2001-223122

Patent Document Japanese Patent Application Laid-Open No. 2002-353044

Patent Document Japanese Patent Application Laid-Open No. 2004-103316

Patent Document Japanese Patent Application Laid-Open No. 2004-111417

### SUMMARY OF THE INVENTION

Problems to be Solved

The present invention has been made in light of the circumstances described above, and it is an object of the present invention to provide an inverter transformer which uses a one end open core formed as one integral component, wherein a gap in a magnetic path is maintained constant thereby reducing variation in leakage inductance while processes and adjustment works in assembly are simplified thus reducing the production cost.

Means for Solving the Problems

In order to achieve the object described above, according to an aspect of the present invention, there is provided an inverter transformer which includes: a magnetic core, and at least one bobbin which defines a hollow, and which each have a primary winding and a secondary winding wound therearound. The magnetic core integrally includes: two side legs; at least one inner leg which are disposed between the two side legs (6), and which are each inserted in the hollow of the bobbin; and a connection bar to connect respective one ends of the side and inner legs thus defining a proximal end portion while respective other ends of the side and inner legs are separated from each other thus defining a distal end portion.

In the aspect of the present invention, the magnetic core may include a plurality of inner legs each having the bobbin disposed therearound.

In the aspect of the present invention, the bobbin may each include an engaging mechanism which is provided at the distal end portion and/or the proximal end portion of the bobbin, and which is composed of a ridge formed at a lateral side of the end portion of the bobbin and a groove formed at a lateral side thereof opposite to the lateral side provided with the ridge, whereby adjacent two bobbins are fixedly coupled to each other such that the ridge of one bobbin engages with the groove of the other bobbin.

In the aspect of the present invention, the bobbin may include two projections which are formed respectively at the both opposite lateral sides of the distal end portion of the bobbin, and which each extend laterally and outwardly so as to reach behind the side leg of the magnetic core, and a means for restricting a tilt of the bobbin structured by the two projections formed at the distal end portion of the bobbin and the connection bar constituting the proximal end of the magnetic core.

In the aspect of the present invention, an adhesive may be applied to an area of the distal end portion of the bobbin joining the side leg of the magnetic core, and/or an area of the proximal end portion of the bobbin joining the connection bar of the magnetic core.

In the aspect of the present invention, the joining area which is located between the distal end portion of the bobbin and the side leg of the magnetic core and to which the adhesive is applied may include part of the projection.

Effects of the Invention

Since the inverter transformer according to the present invention uses a one end open core which is made by molding so as to integrally include side legs, inner legs, and a connection bar to connect respective one ends of the side and inner legs, and is adapted to maintain a uniform gap between the side leg and the inner leg thus suppressing variation in leakage inductance, currents flowing in CCFLs defined as loads of the inverter transformer are equalized. Also, since assembly and adjustment works at the production process are saved or eliminated, the production cost of the inverter transformer can be reduced.

In the inverter transformer according to the present invention, projections are formed at the both lateral sides of the distal end portion of a bobbin so as to extend outwardly and reach behind the side legs of the core, and at the same time the connection bar of the core is positioned at the observe side of the proximal end portion of the bobbin, whereby the bobbin has its distal and proximal ends supported by the core, and therefore when the inverter transformer is mounted on a printed circuit board, the one end open core achieves a mechanical strength comparable to that of a quadrangular frame core with a closed magnetic path structure.

And, an adhesive, which is applied to an area of the projection of the bobbin joining the side leg of the core, can be well contained at the area by the projection, thus ensuring a solid attachment of the bobbin to the core at its distal end portion.

### BRIEF DESCRIPTION OF THE DRAWINGS

FIG. 1 is a schematic top plan view of an inverter transformer according to a first embodiment of the present invention, including two bobbins;

FIG. 2 is a schematic top plan view of an inverter transformer according to a second embodiment of the present invention, including one bobbin;

FIGS. 3(a) to 3(e) are top plan views of example cores included in the inverter transformer according to the present invention;

FIG. 4(a) is a perspective view of a core of FIG. 3(c) showing its obverse side, and FIG. 4(b) is a perspective view of the core of FIG. 4(a) showing its reverse side;

FIG. 5(a) is a left side view of an example bobbin included in the inverter transformers according to the first and second embodiments, and FIGS. 5(b) and 5(c) are respectively front and right side views of the bobbin of FIG. 5(a);

FIG. 6 is a schematic top plan view of two coupled bobbins, each thereof shown in FIG. 5(a);

FIG. 7(a) is a cross sectional view of the bobbin of FIG. 5(a), and FIG. 7(b) is a cross sectional view of the bobbin of FIG. 5(a) with a core inserted therein;

FIG. 8(a) is a schematic top plan view of the inverter transformer according to the first embodiment, showing adhesives applied for fixedly attaching a bobbin to a core, and FIG. 8(b) is an enlarged view of a relevant portion of FIG. 8(a);

FIG. 9 is a schematic top plan view of an inverter transformer according to a third embodiment of the present invention, including two bobbins each having projections;

FIG. 10 is a schematic top plan view of an inverter transformer according to a fourth embodiment of the present invention, including one bobbin having projections;

FIG. 11(a) is a left side view of an example bobbin included in the inverter transformers according to the third and fourth embodiments, and FIGS. 11(b) and 11(c) are respectively front and right side views of the bobbin of FIG. 11(a);

FIG. 12 is a schematic top plan view of two coupled bobbins, each thereof shown in FIG. 11(a);

FIG. 13(a) is an enlarged view of a portion A of FIG. 9, and FIG. 13(b) is a side view of FIG. 13(a) showing an engagement of a bobbin and a core;

FIG. 14(a) is a schematic top plan view of the inverter transformer according to the third embodiment, showing adhesives applied for fixedly attaching a bobbin to a core, and FIG. 14(b) is an enlarged view of a relevant portion of FIG. 14(a); and

FIG. 15 is a schematic top plan view of an inverter transformer shown as a modification example of the present invention, including a core with three inner legs.

### BEST MODES FOR CARRYING OUT THE INVENTION

Exemplary embodiments of the present invention will be described with reference to the accompanying drawings.

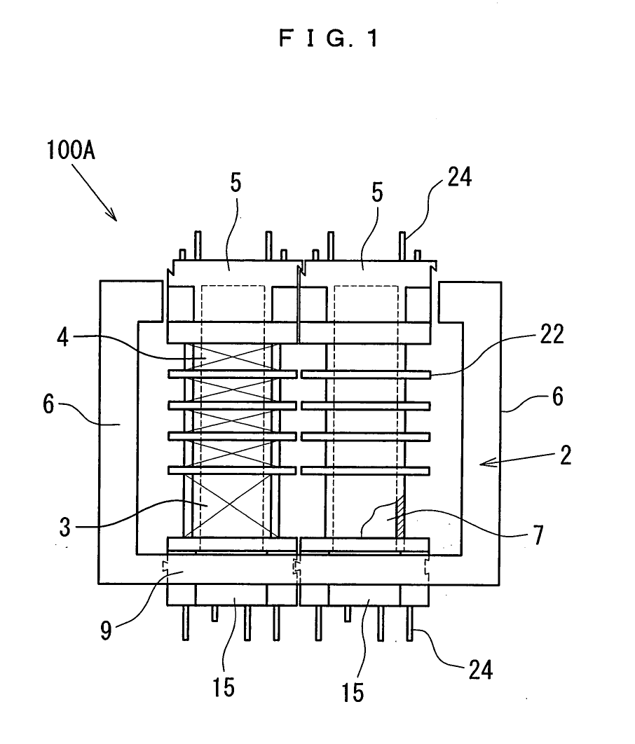

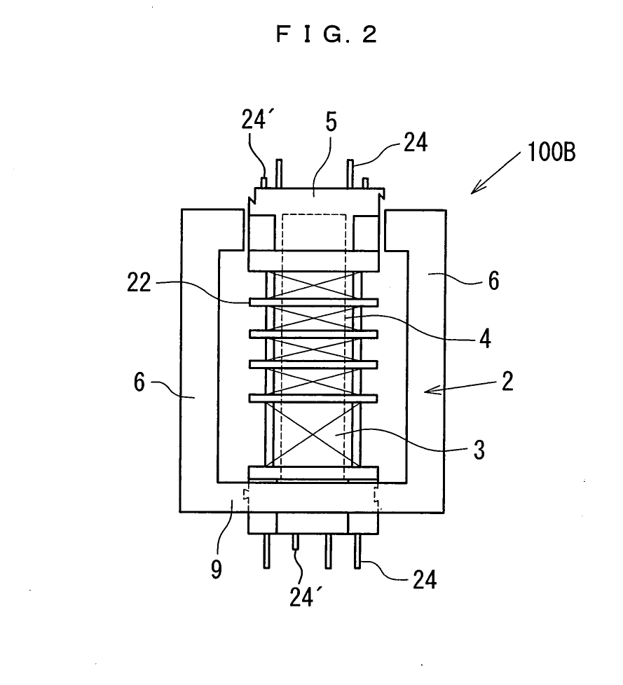

First and second embodiments of the present invention will be described with reference to FIG. 1 to FIGS. 8(a) and 8(b). FIG. 1 shows an inverter transformer 100A according to the first embodiment, and FIG. 2 shows an inverter transformer 100B according to the second embodiment.

Referring to FIG. 1, the inverter transformer 100A includes a core 2 of one end open type, and two bobbins 5 and 5 each having a primary winding 3 and a secondary winding 4 disposed therearound (in FIG. 1, the primary and secondary windings 3 and 4 are indicated only at one bobbin 5 shown on the left side). The two bobbins 5 are shaped and structured identically with each other and coupled to each other. Referring to FIG. 2, the inverter transformer 100B according to the second embodiment includes one bobbin 5 rather than two, which differentiates the inverter transformer 100B from the inverter transformer 100A.

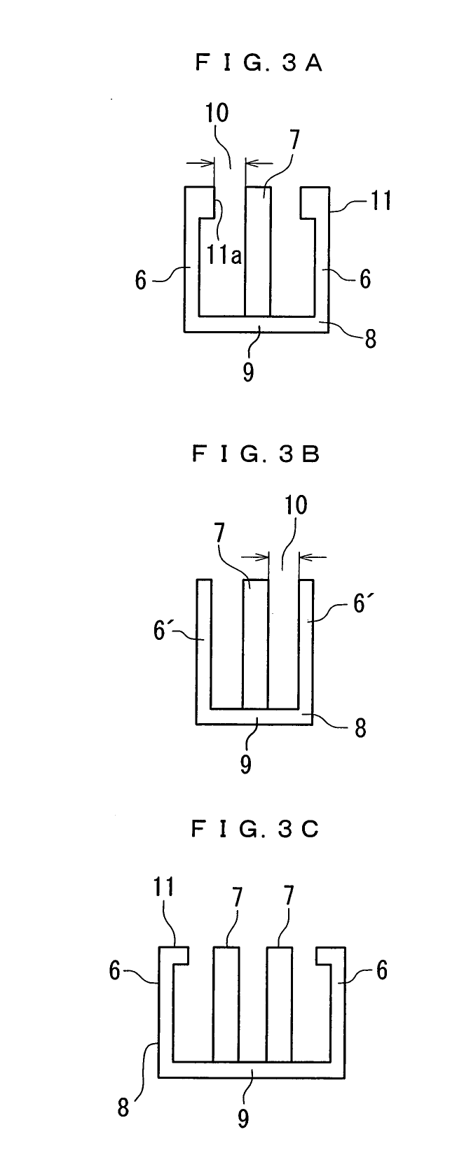

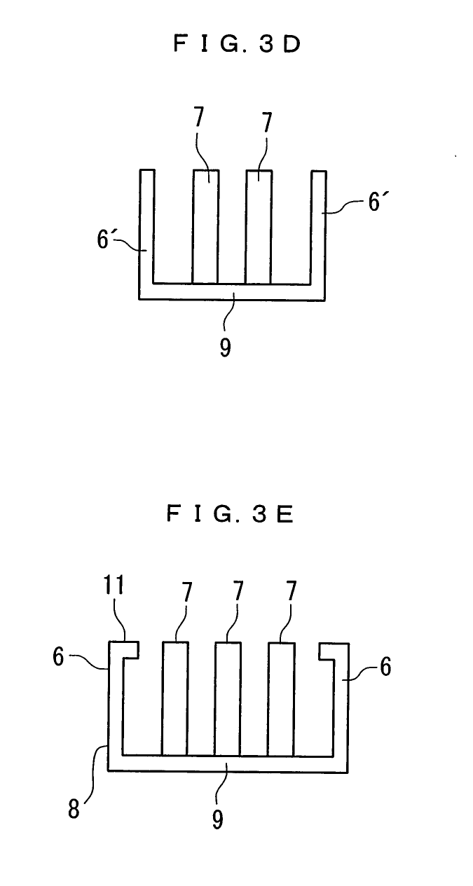

The core 2 is made of a magnetic material by molding as a single piece. Referring to FIGS. 3(a) to 3(d) showing example cores in the present invention, the core 2 integrally includes two side legs 6 and 6 (or 6′ and 6′), one or two inner legs 7, and a connection bar 9. Respective one ends of the legs 6(6′) and 7 are jointed to the connection bar 9 thus defining a proximal end 8, and respective other ends thereof are separated from each other with a gap 10 provided between the side leg 6(6′) and the inner leg 7 thus defining a distal end 11. In this connection, an inner face 11a of the leg 6 located toward the distal end 11 of the core 2 protrudes inwardly, which is preferable for narrowing the gap 10 in order to reduce the gap of the magnetic circuit and also to concentrate the magnetic flux density. FIG. 3(e) shows an example core having three inner legs 7 between two side legs 6.

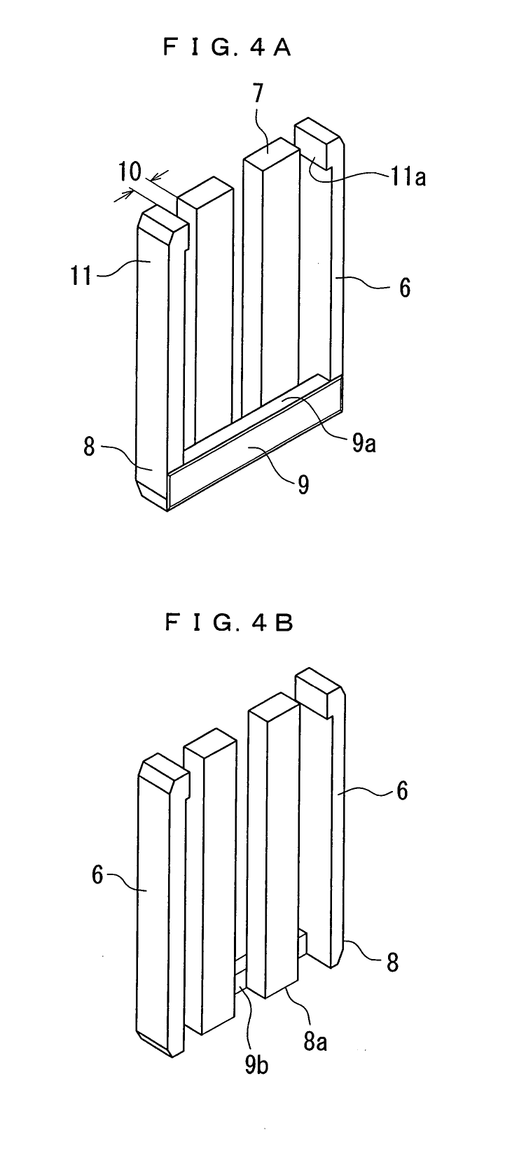

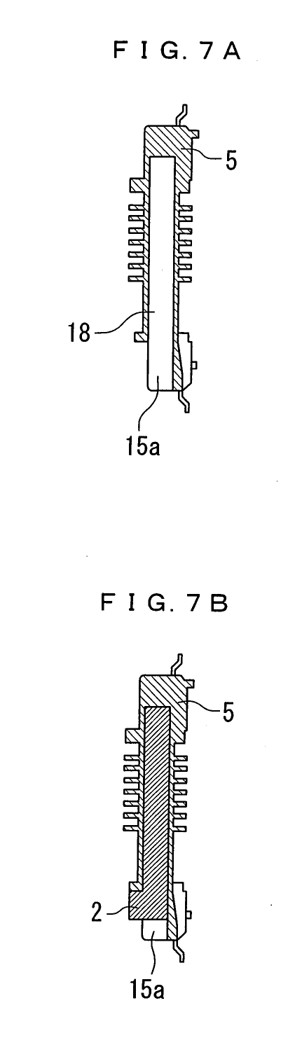

Referring to FIGS. 4(a) and 4(b) respectively showing the obverse and reverse sides of one example core 2 as shown in FIG. 3(c), the core 2 is integrally composed of the legs 6 and 7 and the connection bar 9, has its distal end 11 structured open, and has its proximal end 8 structured such that the connection bar 9 is located at the obverse sides of the legs 6 and 7, thus forming a core of one end open type. Accordingly, the core 2 has an L shape in a side cross sectional view at the inner leg 7 (refer to FIG. 7(b)). An upper face 9a of the connection bar 9 constitutes a seat for receiving a flanged proximal portion of the bobbin 5, and an reverse face 9b of the connection bar 9 makes contact with the observe side of a first terminal block (to be described later) 15 of the bobbin 5. The inner leg 7 has a smaller anterior-posterior dimension than the side leg 6, has a rectangular cross section, and extends vertically to a lower face 8a of the proximal end 8

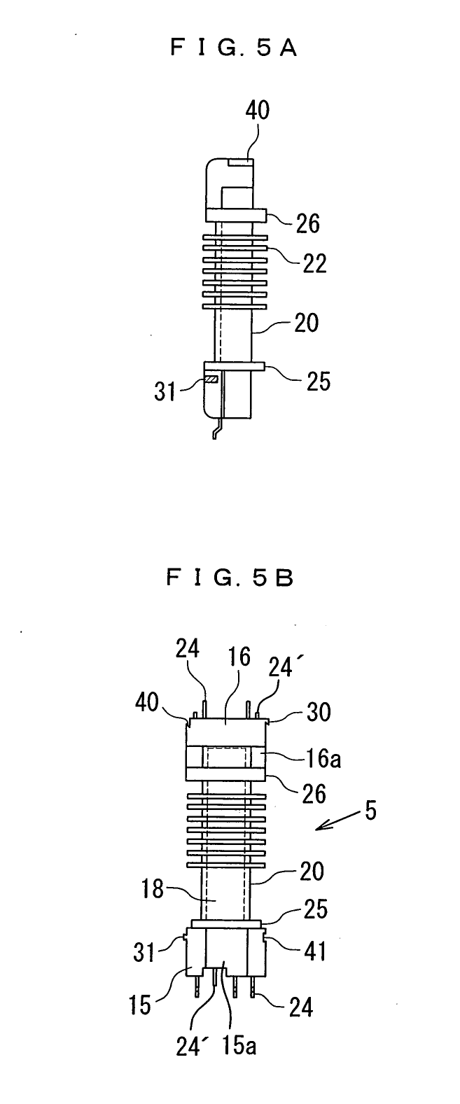

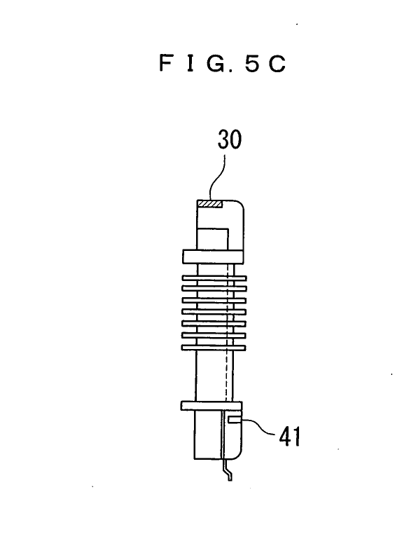

Description will now be made on the bobbin 5 with reference to FIGS. 5(a) to 5(c) together with FIGS. 1, 4(a), 4(b), 6, 7(a) and 7(b). The two bobbins 5 shown in FIG. 1 have an identical configuration, and referring to FIGS. 5(a) to 5(c), each bobbin 5 is formed into a rectangular cylinder and includes a spool 20, the aforementioned first terminal block 15 located at the lower end of the spool 20 toward the primary winding 3, and a second terminal block 16 located at the upper end of the spool 20 toward the secondary winding 4. The first and second terminal blocks 15 and 16 each have a terminal 24 to be connected to the primary winding 3 and a terminal 24′ to be connected to the secondary winding 4, and the spool 20 located between the first and second terminal blocks 15 and 16 has the primary and secondary windings 3 and 4 disposed therearound. The second terminal block 16 has a recess 16a at each of its both lateral sides, and the spool 20 has a plurality of partitions 22 for splitting the secondary winding 4 and has a flange 25 and a flange 26 located at its respective borders with the first and second terminal blocks 15 and 16.

The bobbin 5 has a hollow 18 which goes longitudinally through the bobbin 5 from a core insertion mouth 15a at the first terminal block 15 via the spool 20 to the middle of the second terminal block 16 thus forming a blind hole as shown in FIG. 7(a). FIG. 7(b) shows that the inner leg 7 of the core 2 is received in the hollow 18. The bobbin 5 further includes a ridge 30 and a notched groove 40 respectively at the both lateral sides of the second terminal block 16, and a ridge 31 and a groove 41 respectively at the both lateral sides of the first terminal block 15. The ridges 30 and 31 engage respectively with the grooves 40 and 41 when two of the bobbins 5 are coupled to each other.

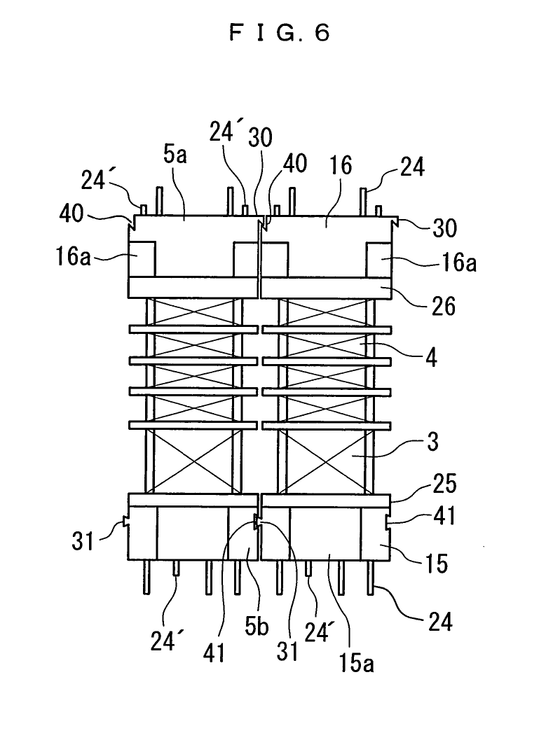

Thus, the bobbin 5 is provided with two engaging mechanisms. Specifically, referring to FIG. 6, one mechanism located at an end portion (distal end portion) 5a works as a hook joint composed of the ridge 30 and the groove 40 formed at the respective edges of the right and left sides (right and right in the figure) of the terminal block 16, and the other mechanism located at an end portion (proximal end portion) 5b works as a dovetail joint composed of the ridge 31 and the groove 41 formed at the respective middle portions of the left and right sides (left and left in the figure) of the terminal block 15.

The two bobbins 5 (one bobbin shown at left in the figure is referred to as first bobbin, and the other bobbin shown at right in the figure is referred to as second bobbin) are coupled to each other in the following manner. The ridge 30 of the first bobbin 5 and the groove 40 of the second bobbin 5 are hooked to each other, then the terminal block 15 of the second bobbin 5 with the ridge 31 is raised in the obverse direction with respect to the terminal block 15 of the first bobbin 5 with the groove 41 and is pressed down with the ridge 31 of the second bobbin 5 sliding into the groove 41 of the first bobbin 41. Thus, the first and second bobbins 5 and 5 are coupled to each other in place fixedly in the vertical and lateral directions.

The method of assembling the bobbin 5 and the primary and secondary windings 3 and 4 will be described. In case of using two of the bobbins 5 as shown in FIG. 6, the primary winding 3 and the secondary winding 4 (partitioned into a plurality of divisions) are wound around each of the two bobbin 5 and 5, then the two bobbins 5 and 5 are combined to each other with the ridges 30 and 31 engaging with the grooves 40 and 41 as described above, and the primary windings 3 and 3 are connected to each other in series or in parallel while the secondary windings 4 and 4 are connected to the respective terminals 24′, thus the two bobbins 5 and 5 with the primary and secondary windings 3 and 4 are duly coupled to each other. In case of using one bobbin 5 for the core 2 having one inner leg 7 as in the second embodiment shown in FIG. 2, the bobbin combining process and the winding connecting process are omitted.

Then, the bobbins 5 with the primary and secondary windings 3 and 4 are each telescoped over the inner leg 7 of the core 2 such that the distal end of the inner leg 7 is introduced into the hollow 18 of the bobbin 5 from the core insertion month 15a. The core 2 with its distal end 11 structured open cannot duly support the distal end portion 5a of the bobbin 5 into which the inner leg 7 is just inserted. Also, the core 2 itself, which is structured such that only one ends of the side legs 6 and the inner leg(s) 7 are connected by the connection bar 9 thus forming a cantilever structure, tends to sag and deform. With this core structure, when an obverse-to-reverse or side-to-side force is applied to the distal end portion 5a of the bobbin 5, a stress may be given to the proximal end area of the inner leg 7 and also the side leg 6 possibly causing breakages.

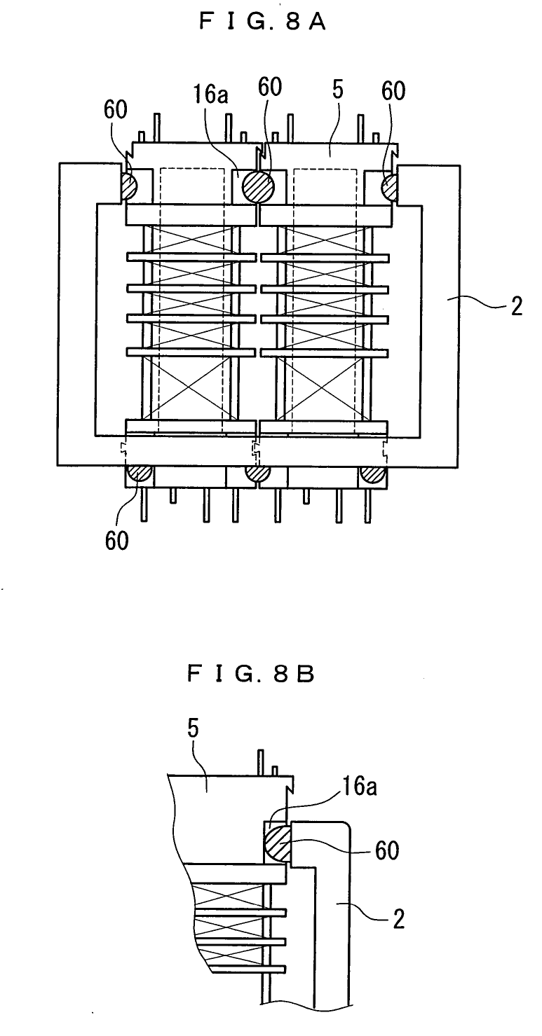

In the present invention, while the bobbin 5 is adapted to be smoothly telescoped over the leg 7 of the core 2, only a limited gap is provided between the inner face 11a of the distal end area of the side leg 6 and the lateral side face of the second terminal block 16 of the bobbin 5 thereby providing some means for restricting movement of the bobbin 5 with respect to the side-to-side direction. However, unlike a quadrangular frame core, the core 2 structured with one end open is not duly provided with a means for fixedly supporting the bobbin 5 with respect to the obverse-to-reverse direction. Accordingly, when a stress is given to the bobbin 5, the inner leg 7 may possibly have its proximal end area broken as described above. Also, the bobbin 5 shaking due to the cantilever structure of the core 2 causes variation in leakage inductance of an inverter transformer. Under the circumstances described above, in order to securely combine the bobbins 5 with the core 2, an adhesive 60 is applied to the recesses 16a of the second terminal blocks 16 of the bobbins 5, and also to the joining areas between the first terminal blocks 15 of the bobbins 5 and the connection bar 9 of the core 2 as shown in FIGS. 8(a) and 8(b). The adhesive 60 is preferably large in viscosity.

The core 2 is made as a single piece integrally including the side legs 6, the inner legs 7 and the connection bar 9, and therefore reduces the assembly processes, and also ensures a constant gap distance between the side and inner legs 6 and 7 thus suppressing variation from component to component, whereby fluctuation in leakage inductance is eliminated and an excellent inverter transformer is obtained. With elimination of leakage inductance fluctuation, currents flowing in CCFLs defined as the loads of the inverter transformer are equalized.

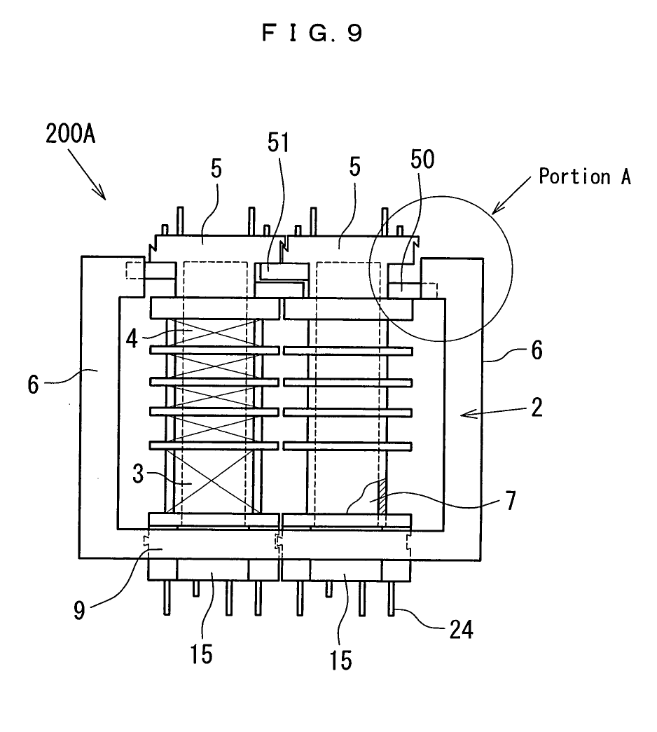

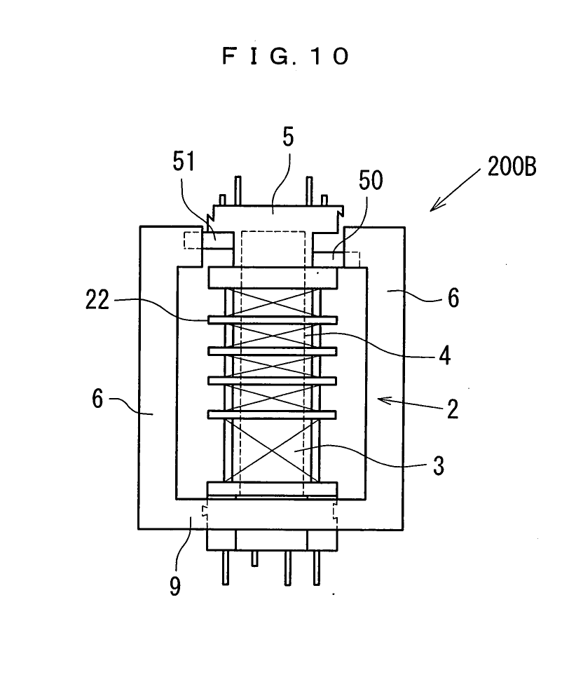

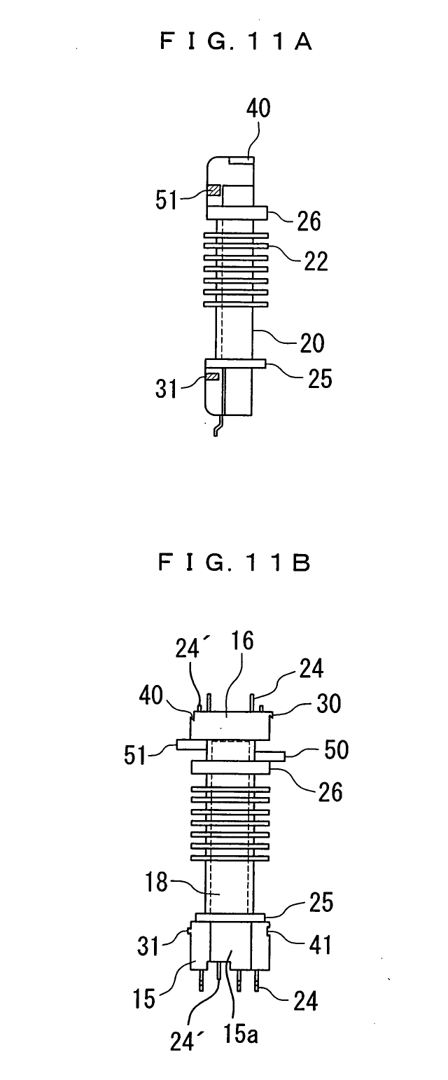

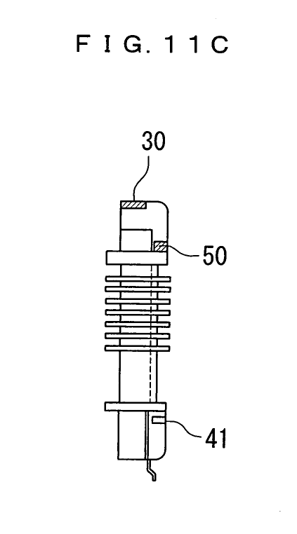

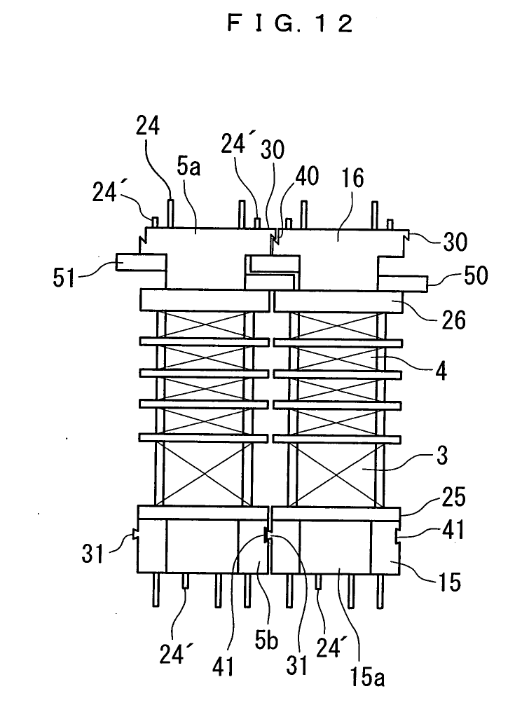

Third and fourth embodiments of the present invention will be described with reference to FIG. 9 to FIGS. 14(a) and 14(b). FIG. 9 shows an inverter transformer 200A according to the third embodiment, and FIG. 10 shows an inverter transformer 200B according to the fourth embodiment. In explaining the inverter transformers 200A and 200B of FIGS. 9 and 10, description will be focused on the differences from the inverter transformers 100A and 100B of FIGS. 1 and 2, any component parts corresponding to those in FIGS. 1 and 2 are denoted by the same reference numerals, and a detailed description thereof will be omitted below.

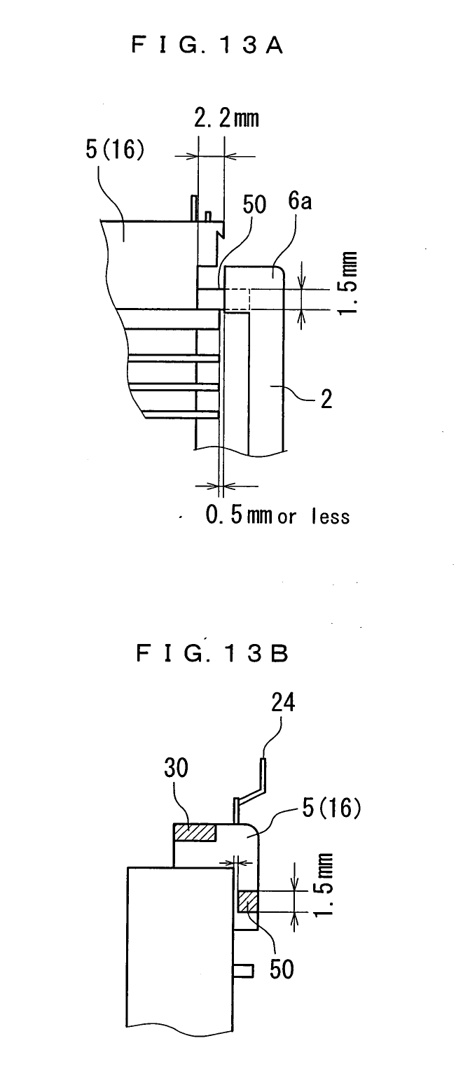

Referring to FIG. 9/10, the inverter transformer 200A/200B differs from the inverter transformer 100A/100B of FIG. 1/2 in that a bobbin 5 has two projections 50 and 51 formed at a second terminal block 16 in two respective different plane levels and extending laterally in parallel to each other in the respective opposite directions. Referring to FIGS. 13(a) and 13(b), the projection 50 extends laterally from one lateral side (right in FIG. 9/10) of the second terminal block 16 and has a substantially square cross section with a side dimension of about 1.5 mm. The projection 50 is positioned at the rear portion of the second terminal block 16, and extends outwardly so as to pass the plane of the inner face 11a of the side leg 6 and to protrude therefrom about 1.5 mm thus reaching behind the side leg 6 of the core 2. Referring now to FIG. 12, the projection 51 having the same shape as the projection 50 extends laterally from the other lateral side (left in the figure) of the second terminal block 16. The projection 51 is disposed at a plane level different from that of the projection 50 such that in case of using two of the bobbins 5 and 5, the projection 50 of the first bobbin 5 (left in the figure) is positioned under the projection 51 of the second bobbin 5 (right in the figure) with a bare clearance therebetween at the adjacent area between the first and second bobbins 5 and 5 coupled to each other, while the projection 51 of the first bobbin 5 and the projection 50 of the second bobbin 5 extend outwardly to reach behind respectively the upper and lower sides of the inwardly protruding distal end areas of the side legs 6 (refer to FIGS. 9 and 12). The projections 50 and 51 may have their distal end corners rounded.

The core 2 is of one end open type, and therefore there is provided a means for restricting the shaking and tilting of the bobbin 5 disposed on the inner leg 7 of the core 2. The shake and tilt restricting means is adapted to work as follows. Referring again to FIG. 13(a), the lateral side face of the side leg 6, which closely opposes the lateral side of the bobbin 5, restricts the bobbin 5 from laterally shaking at the distal end portion 5a, and referring to FIG. 13(b), the projection 50 of the bobbin 5 is located at the reverse face of the side leg 6 with a limited gap of about 0.2 mm therebetween, whereby the bobbin 5 is restricted from tilting forward at the distal end portion 5a. The bobbin 5 is attached to the core 2 such that the flange 25 of the bobbin 5 sits on the upper face 9a of the connection bar 9 with the observe face of the first terminal block 15 butting with the reverse face 9b of the connection bar 9, and that the projection 50/51 extending from the terminal block 16 is located behind the side leg 6. With this structure, the bobbin 5 is suppressed from tilting forward with its proximal end portion 5b (the first terminal block 15) supported by the reverse face 9b of the connection bar 9 and with its distal end portion 5a (the second terminal block 16) supported by the reverse face of the distal end area of the side leg 6. Accordingly, when the inverter transformer structured above is mounted on a printed circuit board, the core 2 of one end open type is adapted to support both the distal and proximal ends 5a and 5b of the bobbin 5 like a quadrangular frame core with a closed magnetic path, thus preventing the inner leg 7 from suffering breakage attributable to the tilt of the bobbin 5.

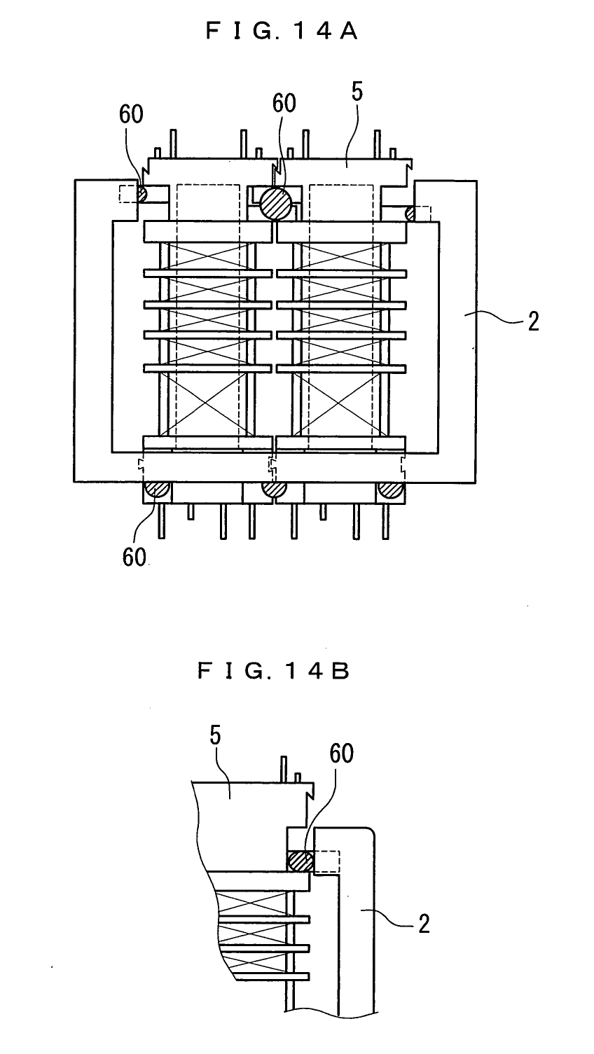

In order to attach the bobbin 5 to the core 2 more securely, the bobbins 5 are adhesively fixed to the bobbin 6 as shown in FIG. 14(a). Specifically, an adhesive 60 is applied to an area of the projection 50/51 of the bobbin 5 joining the inner face 11a of the distal end area of the side leg 6 and, to an area of the proximal end portion 5a (the first terminal block 15) of the bobbin 5 joining the connection bar 9 of the magnetic core 2, and also to an area of the projections 50 and 51 overlapping each other where the adhesive 60 is well contained thus enabling a rigid adhesion.

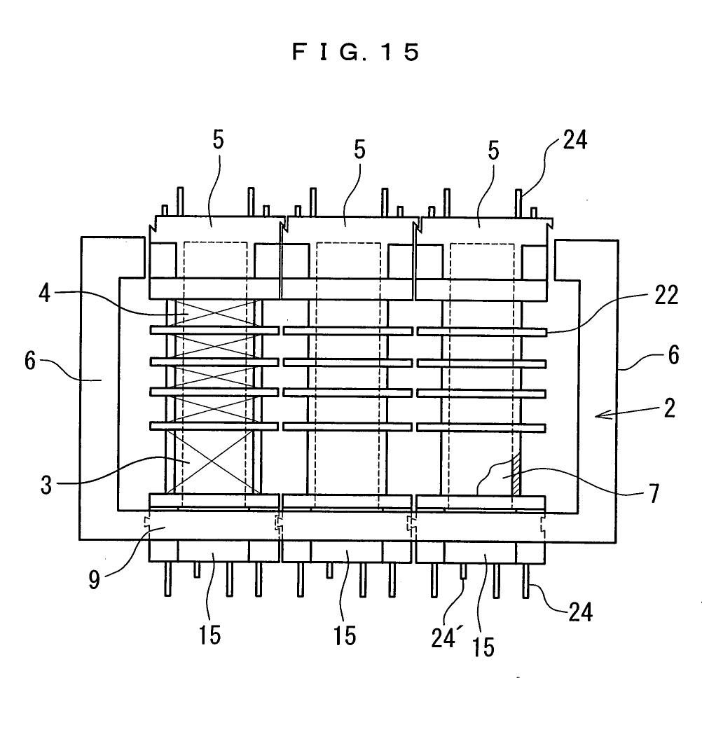

In the embodiments described above, one end open cores with one or two inner legs are cited, but the present invention is not limited to this structure and can be carried out with a one end open core having three or more inner legs. For example, FIG. 15 shows an inverter transformer incorporating a one end open core with three inner legs (refer to FIG. 3(e)). Also, in the embodiments described above using two or more bobbins, the bobbins are shaped identical with each other, but the present invention is not limited to this structure and can be feasible with a plurality of bobbins shaped substantially identical with each other or different from each other.

1. An inverter transformer comprising:
a magnetic core integrally comprising: two side legs; at least one inner leg disposed between the two side legs; and a connection bar to connect respective one ends of the side and inner legs thus defining a proximal end portion while respective other ends of the side and inner legs are separated from each other thus defining a distal end portion; and
at least one bobbin defining a hollow to have the inner leg inserted therein, each bobbin having a primary winding and a secondary winding wound therearound,
wherein an adhesive is applied to at least one of: a joining area between the distal end portion of the bobbin and the side leg of the magnetic core; and a joining area between the proximal end portion of the bobbin and the connection bar of the magnetic core.

2. An inverter transformer according to claim 1, wherein the magnetic core comprises a plurality of inner legs each having the bobbin disposed therearound.

3. An inverter transformer according to claim 1, wherein the bobbin each comprises an engaging mechanism which is provided at least one of the distal end portion and the proximal end portion of the bobbin, and which is composed of a ridge formed at a lateral side of the end portion of the bobbin and a groove formed at a lateral side thereof opposite to the lateral side provided with the ridge, whereby adjacent two bobbins are fixedly coupled to each other such that the ridge of one bobbin engages with the groove of the other bobbin.

4. An inverter transformer according to claim 1, wherein the bobbin comprises two projections which are formed respectively at both opposite lateral sides of the distal end portion of the bobbin, and which each extend laterally and outwardly so as to reach behind the side leg of the magnetic core, and wherein a means for restricting a tilt of the bobbin is structured by the two projections formed at the distal end portion of the bobbin and the connection bar constituting the proximal end of the magnetic core.

5. (canceled)

6. An inverter transformer according to claim 4, wherein the joining area which is located between the distal end portion of the bobbin and the side leg of the magnetic core and to which the adhesive is applied comprises part of the projection.
